(19) United States
(12) Patent Application Publication
(10) Pub. No.: US 2013/0268331 A1
(43) Pub. Date: Oct. 10, 2013

(54) METHODS AND SYSTEMS FOR PROVIDING ONLINE GROUP SHOPPING SERVICES

(71) Applicants: Gadi Lifshitz, Kiryat Ono (IL); Eui Chung, Huntley, IL (US); Guy Haimovitch, Kfar Saba (IL)

(72) Inventors: Pasha Bitz, Tel-Aviv (IL); Gadi Lifshitz, Kiryat Ono (IL); Eui Chung, Huntley, IL (US); Guy Haimovitch, Kfar Saba (IL)

(73) Assignee: SEARS BRANDS, LLC, Hoffman Estates, IL (US)

(21) Appl. No.: 13/443,613

(22) Filed: Apr. 10, 2012

(51) Int. Cl. G06Q 30/06

(52) U.S. Cl. CPC G06Q 30/0631
USPC 705/14.16; 705/26.7; 705/14.27

(57) ABSTRACT

A method and system for providing an online group shopping experience via a computing device includes hosting a database of information regarding a first and second user, and associating the two user records. The group shopping experience is provided with a user interface for the first user and a user interface for the second user. The first user is provided with the ability to selectively share a summary of the information displayed on the first user's interface and the second user is provided with the ability to selectively navigate to and display the information displayed by the first user on the second user's interface.

### FIELD OF THE DISCLOSURE

The present description relates generally to group shopping activities, and more particularly to methods and systems for providing online group shopping services.

### BACKGROUND OF RELATED ART

Group shopping experiences have traditionally been provided by an in-store trip including a plurality of shoppers. A group shopping trip is oftentimes productive for both the provider and the shopper. In particular, when collaborating with other individuals, the customer gets the added benefit of multiple opinions, social interactions, gamification, etc, and the retailer gets the added benefit of a higher likelihood of conversion of sale. While shopping together has been successful for a number of years in an in-store environment, the ability for multiple individuals to participate in on-line shopping ventures has been limited to multiple individuals viewing the same on-line display, thus limiting the effectiveness of the shopping together experience.

With the advent of both online shopping and social media, the ability to merge online shopping and social media functions together has been a difficult objective to achieve. In one example, US 2010/0030578 to Siddique generally discloses a system that supports four modes of operation for a shopping trip: regular, asynchronous, synchronous, and common. In the regular mode, a single user can shop for products in the standard way, i.e. by browsing catalogues, selecting items for review, and purchasing those desired items. The regular mode of Siddique, however, involves a single user and does not provide for any collaborative shopping experiences.

In the asynchronous mode, the user can collaborate with other shoppers in an asynchronous fashion. The asynchronous mode does not provide for a situation where other shoppers the user wishes to collaboratively shop with are online. Rather, the user can share images, videos, reviews and other links of products and stores they wish to show other users by dragging and dropping content into a share folder. The user can send others offline messages, and itemized lists of products sorted according to ratings, price, or some other criteria, but the user does not necessarily obtain any of the benefits of true collaborative real-time online shopping.

Meanwhile, the synchronous and common modes of Siddique require all collaborating members to be online and while the two modes permit synchronized sharing, communications, and other electronic collaborative operations, the users rely upon a full real-time sharing of all web browsing locations and cannot selectively share shopping information with others users.

While the background systems and methods identified herein, generally work for their intended purpose, the subject invention provides improvements thereto, particularly by providing systems and methods for an online group shopping experiences by allowing selective sharing of various searching and/or browsing techniques and by tapping into a consumer's social network of individuals who know and understand the consumer on a personal level.

### SUMMARY

In the present disclosure, the system allows multiple users to shop together with friends. The system provides for browsing the same pages at the same time, while selectively sharing search and/or result data. The system provides for mobile and/or desktop device connectivity and includes multi-channel integration in a social networking and retail environment. In one example, the system provides for an experience just like being in the shopping mall together, without leaving a user's couch.

In one example, when a friend starts sharing his/her browsing with a user, by “watching” the friend's browsing history, the system will automatically take the user to the same page the friend is browsing at this moment, without having to real-time update the browser/device actions (e.g., does not have to follow typing/clicking in real-time).

In one example of the system described herein, the shopping together network allows for a user to “share” browsing and selectively choose which pages the friend wishes to view. Alternatively, if the user's friends want, they can start “watching” the user and be taken to whatever page you're browsing. For example, if a chat partner is sharing browsing but the user is not “watching”, the user will not be automatically redirected to the pages browsed by the chat partner but the pages will still appear in the content area of the chat room. In this way, the system can selectively choose which pages they wish to be actively navigated to.

In order to accomplish the consummation and development of an online group shopping experience, one example of the presently disclosed system provides a group of shoppers with the tools necessary to connect and shop through at least the use of a retail online store and/or a social networking site. For instance, the present system allows existing online shoppers to be engaged in an online group shopping experience by providing the ability to selectively share browsing history with others and to selectively watch other users in their shopping without having to be physically located at a retail environment and/or contemporaneously located on the same computing network/display.

In addition, in another example of the present disclosure, multichannel retailing, including both online and offline activities may be influenced by the group shopping experience. In other words, a group of shoppers may participate in an online group shopping experience that ultimately translates into an in-store purchase. As such, in one example, the system may provide for rewards, and/or other incentives corresponding to both online and retail purchases influenced and tracked by the system. Still further, the online and/or offline tracking may be conducted within the corporate establishment hosting the system and/or may be within a network of establishments through partnerships, cooperation, etc. The group dynamics in the shopping experience may be used by the disclosed system for ecommerce, social media, retail, multichannel retail, mobile, and tablet enhancements as well as the gamification of a customer experience (e.g., viral marketing, campaigning, gaming, funware, etc.). In one example, the application enables a customer to find and communicate with other friends, including sales associates, friends, social connections, and/or personal shoppers to conduct a one-to-one, one-to-many, and/or a many-to-many communication to accomplish an online group purchasing experience and ultimately to achieve a higher level of customer satisfaction and repeat patronage.

Still further, while the present disclosure is directed towards a retail environment, it will be appreciated by one of ordinary skill in the art that the shopping together experience may span any viable shopping opportunity. For instance, the product being shopped for may be any of a retail product, a service, an expert, and/or any other suitable item/product/service as desired.

### BRIEF DESCRIPTION OF THE DRAWINGS

For a better understanding of the present disclosure, reference may be had to various examples shown in the attached drawings.

FIG. 1 illustrates in block diagram form components of an example, computer network environment suitable for implementing the example online group shopping system disclosed.

FIG. 2 illustrates an example online group shopping system in accordance with the present disclosure.

FIG. 3 illustrates a flowchart of an example process of the disclosed online group shopping system in accordance with the present disclosure.

FIG. 4 illustrates an example user interface after authorizing a user with the example online group shopping system in accordance with the present disclosure.

FIG. 5 illustrates an example user interface for displaying additional user information in accordance with the present disclosure.

FIG. 6 illustrates an example user interface for displaying a listing of user information in accordance with the present disclosure.

FIG. 7 illustrates an example user interface for displaying a chat box in accordance with the present disclosure.

FIG. 8 illustrates an example user interface viewed by a second user showing the results of a selective sharing of browsing in accordance with the present disclosure.

FIG. 9 illustrates an example user interface viewed by the second user showing the results of a selection by the second user to watch the browsing of the first user.

FIG. 10 illustrates an example user interface as viewed by the first user showing a confirmation that the second user has chosen to watch the first user's browsing.

FIG. 11 illustrates an example user interface as viewed by the second user showing the results of action by the first user to navigate to a new browser page.

FIG. 12 illustrates an example user interface as viewed by the first user showing multiple chat sessions.

FIG. 13 illustrates an example user interface as viewed by the first user showing a confirmation that the second use has navigated to the same page.

FIG. 14 illustrates an example user interface as viewed by the second user showing a summary of the navigation by the first user.

FIG. 15 illustrates an example user interface as viewed by the first user showing a confirmation that the second user will not view the navigated page due to privacy restrictions.

FIG. 16 illustrates an example user interface as viewed by the first user showing a chat room with multiple users.

### DETAILED DESCRIPTION

The following description of example methods and systems is not intended to limit the scope of the description to the precise form or forms detailed herein. Instead the following description is intended to be illustrative so that others may follow its teachings.

An online group shopping application is explained hereinbelow. In general, the application allows for the formation of a connection between a consumer and at least one other individual (e.g., a social network friend) for the purposes of forming a group shopping experience. The disclosed invention leverages mobile and/or desktop online browsing technology, chat functionality, social networking, retail online shopping technology and/or a consumers' social connections, such as through a social media website, to enable each shopper the ability to receive input from multiple people. In this example, the system may leverage a retail establishment's online product catalog, which is oftentimes larger than an in-store inventory to provide a group shopping experience. Specifically, the more people in a shopper's social network that participate in an online shopping experience, the more the group can influence purchasing recommendations.

In the example systems and methods disclosed, a group shopping experience is conducted through the use of a chat and browsing feature. For example, the systems and methods described herein allow users to chat with other users in their social networks and allow them to selectively browse and comment on the same pages at the same time when on a retail website. The shopping experiences presented herein can be selectively shared and/or watched by each user, and the privacy of each shopping experience may be personalized to ensure customized privacy for each individual user.

In one example, the shopping application identifies potential people within a user's social network that may be interested in being an accompanying shopper. Alternatively, a user may search through existing members of the shopping application to request friends for shopping purposes. The friends may be discovered through use of common interests, names, locations, and/or any other suitable search mechanism. Once a relationship is formed, the system allows for shared browsing experience with all, some, or none of the user's friends to provide a group shopping experience. Additionally, the system allows a friend to actively watch the user's shopping, and/or passively see what the user is shopping for while performing their own online shopping excursion. In still other examples, the resulting combination of shopping together and/or group purchases may include vary incentives and/or other gamified outcomes based upon recommendations, etc., to earn a reward, such as for example, reward points, items, and/or cash.

In order to accomplish the consummation and development of an online group shopping experience, the presently disclosed system provides a group of shoppers with the tools necessary to connect and shop through at least the use of a retail online store and/or a social networking site. For instance, the present system allows existing online shoppers to be engaged in a group shopping experience by providing the ability to selectively share browsing history with others and to selectively watch other users in their shopping without having to be physically located at a retail environment and/or contemporaneously located on the same computing network/display.

In the present disclosure, both online and offline activities may be influenced by the group shopping experience. In other words, a group of shoppers may participate in an online group shopping experience that ultimately translates into an in-store purchase. As such, in one example, the system may provide for rewards, and/or other incentives corresponding to both online and retail purchases influenced and tracked by the system. Still further, the online and/or offline tracking may be conducted within the corporate establishment hosting the system and/or may be within a network of establishments through partnerships, cooperation, etc. The group dynamics in the shopping experience may be used by the disclosed system for ecommerce, social media, retail, multichannel retail, mobile, and tablet enhancements as well as the gamification of a customer experience (e.g., viral marketing, campaigning, gaming, funware, etc.). In one example, the application enables a customer to find and communicate with other friends, including sales associates, friends, social connections, and/or personal shoppers to conduct a one-to-one, one-to-many, and/or a many-to-many communication to accomplish an online group purchasing experience and ultimately to achieve a higher level of customer satisfaction and repeat patronage.

In this example system, the consumer's friends may be a personal shopper (e.g., a sales associate) may be an expert, a customer service agent, a friend, an acquaintance, etc., to provide group buying assistance for a consumer's intended purchase. Still further, in some examples, the application allows an individual, such as a personal shopper to proactively contact and/or otherwise communicate with their network to proactively and/or reactively provide merchandise suggestions visible by the person's network. In other words, the system allows an individual to push content to their network (e.g., clients) when they know the networked user may be interested.

In one example, the system provides the use of commodity hardware, off the shelf software, OS independent applications, form factor independent devices (PC, tablets, smart phones etc), media independent (voice, text, video) and cloud based infrastructure to run all functionalities of the present system. In the context of a service establishment, such as, for example, a retail store this is specifically very useful as a customer can utilize familiar technologies and receive relate and personalized support, assistance, product demos, suggestions, etc., which can be handled by a member of the group shopping experience who has the most expertise and/or relevant information and who may be familiar with the products under consideration.

The disclosed methods and systems may be part of an overall shopping experience system created to enhance the consumer shopping event. In one example, the disclosed personal shopping network is integrated with the customer's reward system, the customers social network (e.g., the customer can post their shopping activity conducted through the system to their social network), the customer's expert system, digital/mobile applications, shopping history, wish list, location, merchandise selections, or the like. It will be appreciated, however, by one of ordinary skill in the art that the system disclosed may be fully and/or partially integrated with any suitable shopping system as desired, including those not mentioned and/or later designed.

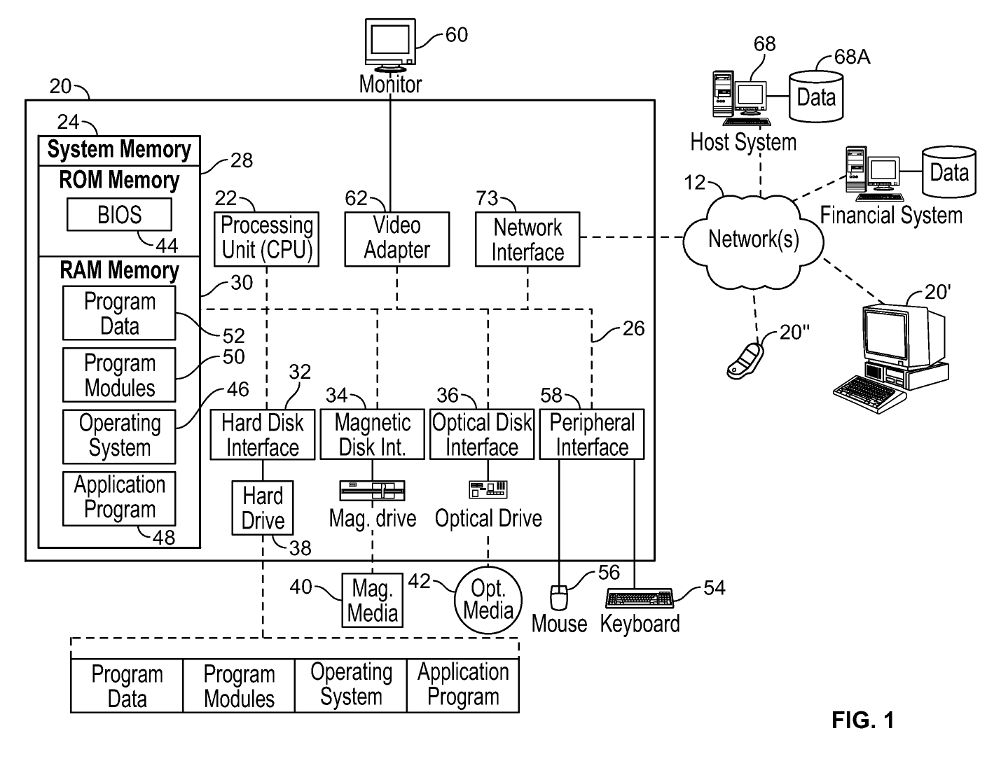

With reference to the figures, the following discloses various example systems and methods for providing an online group shopping experience on a computer network, such as a desktop and/or mobile device. To this end, a processing device 20″, illustrated in the exemplary form of a mobile communication device, a processing device 20′, illustrated in the exemplary form of a computer system, and a processing device 20 illustrated in schematic form, are provided with executable instructions to, for example, provide a means for a customer, e.g., a user, client, group shopper, customer, buyer, consumer, etc., to access a host system server 68 and, among other things, be connected to a hosted online retail environment (e.g. a retail store), a social networking site, a user profile, a sales associate, a personal shopper, etc. Generally, the computer executable instructions reside in program modules which may include routines, programs, objects, components, data structures, etc. that perform particular tasks or implement particular abstract data types. Accordingly, those of ordinary skill in the art will appreciate that the processing devices 20, 20′, 20″ illustrated in FIG. 1 may be embodied in any device having the ability to execute instructions such as, by way of example, a personal computer, a mainframe computer, a personal-digital assistant (“PDA”), a cellular telephone, a mobile device, a tablet, an ereader, or the like. Furthermore, while described and illustrated in the context of a single processing device 20, 20′, 20″ those of ordinary skill in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules, and other data for the processing device 20. Those of ordinary skill in the art will further appreciate that other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, touchpad, touch screen, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as, for example, speakers, cameras, printers, or other suitable device.

As noted, the processing device 20 may also utilize logical connections to one or more remote processing devices, such as the host system server 68 having associated data repository 68A. In this regard, while the host system server 68 has been illustrated in the exemplary form of a computer, it will be appreciated that the host system server 68 may, like processing device 20, be any type of device having processing capabilities. Again, it will be appreciated that the host system server 68 need not be implemented as a single device but may be implemented in a manner such that the tasks performed by the host system server 68 are distributed amongst a plurality of processing devices/databases located at different geographical locations and linked through a communication network. Additionally, the host system server 68 may have logical connections to other third party systems via a network 12, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, systems of banking, credit, or other financial institutions, systems of third party providers of goods and/or services, systems of shipping/delivery companies, etc.

For performing tasks as needed, the host system server 68 may include many or all of the elements described above relative to the processing device 20. In addition, the host system server 68 would generally include executable instructions for, among other things, coordinating a personal shopper relationship, providing a social network, storing a user's personal information, facilitating recommendations, providing access to merchandise, etc.

Communications between the processing device 20 and the host system server 68 may be exchanged via a further processing device, such as a network router (not shown), that is responsible for network routing. Communications with the network router may be performed via a network interface component 73. Thus, within such a networked environment, e.g., the Internet, World Wide Web, LAN, cloud, or other like type of wired or wireless network, it will be appreciated that program modules depicted relative to the processing device 20, or portions thereof, may be stored in the non-transitory memory storage device(s) of the host system server 68.

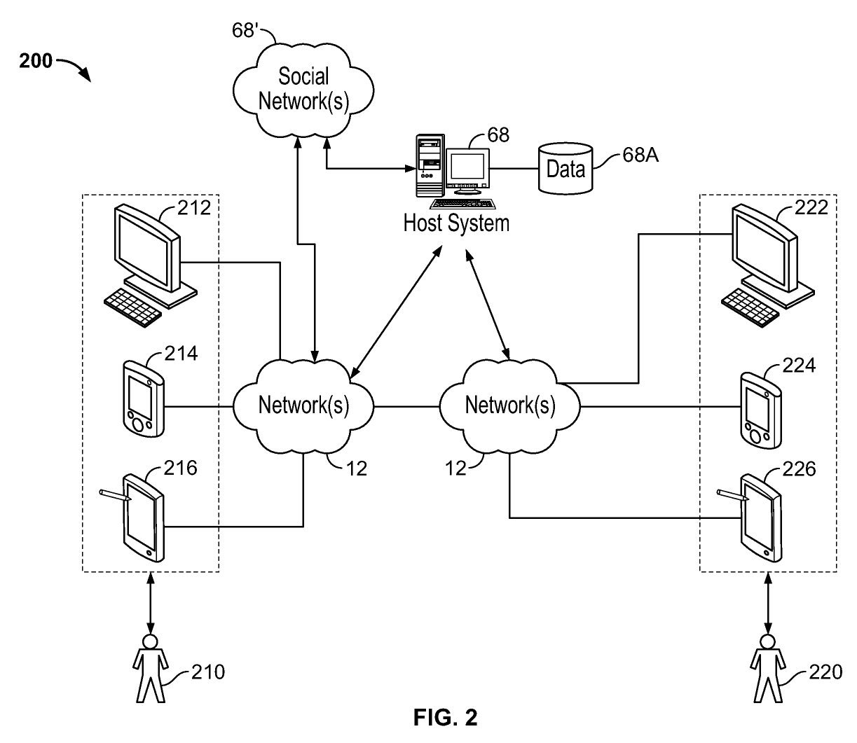

Referring to FIG. 2, there is illustrated an overview of an example inline group shopping system 200 in accordance with an example of the present disclosure. The system 200 is well-suited for operation on a distributed network system, such as, for example, a client-server architecture utilizing the Internet, cloud, mobile network, cellular network, or other suitable wired and/or wireless network. The system 200 may be implemented in various other communication networks and/or mediums as desired including, for example, a localized, non-distributed network.

Generally speaking, the system 200 is operable to facilitate an online shopping experience between at least two users. It will be appreciated by one of ordinary skill in the art that the number of users concurrently using the system 200 may vary as desired. In the illustrated example, a first user 210 may access the system 200 through any suitable device 20, such as a computer system 212, a smart phone 214, a tablet computer 216, or any other suitable known or yet to be developed communication device. In the disclosed example, the communication device 20 is capable of Internet browsing, textual transmission, and/or video transmission (e.g., video chat, video phone, etc), but it will be appreciated by one of ordinary skill in the art that the communication device may be any suitable communication device including any voice, email, and/or text communication with or without use of other transmission types.

Concurrently, in the illustrated example, a second user 220 may also access the system 200 through any suitable device, such as a computer system 222, a smart phone 224, a tablet computer 226, or any other suitable known or yet to be developed communication device. Similar to the first user's devices, the communication devices 222, 224, 226 are each capable of Internet browsing, textual transmission, and/or video transmission (e.g., video chat, video phone, etc) as desired.

For privacy reasons, the shoppers 210, 220 must affirmatively establish a relationship with one another. Once established, each user 210, 220 accesses the host server 68 through the network(s) 12. In this example, each user 210, 220 accesses the system 68 through a separate network 12, but it will be appreciated that the network access may be architected in any suitable manner. Each of the network(s) 12 provides network routing utilizing a cloud based network, although any appropriate routing device (software, firmware, hardware, and/or the like) may be utilized. The connection between the user 210 and the user 220 may be through the network 12, through a social network 68′, and/or through the host system 68.

The illustrated approach may take advantage of the convergence of mobile devices, IP telephony (e.g., VoIP, SIP, etc) and Internet application such as, for example, Facetime, Skype, etc. The example system 200 may also enable interactive communications amongst user across varied platforms, (e.g., iOS, Android, Windows, etc.), devices (e.g., Mobile phones, PCs, Macs, Tablets, etc), networks (e.g., Wi-Fi, 3G, 4G, etc.), and media (e.g., voice, text, video, etc).

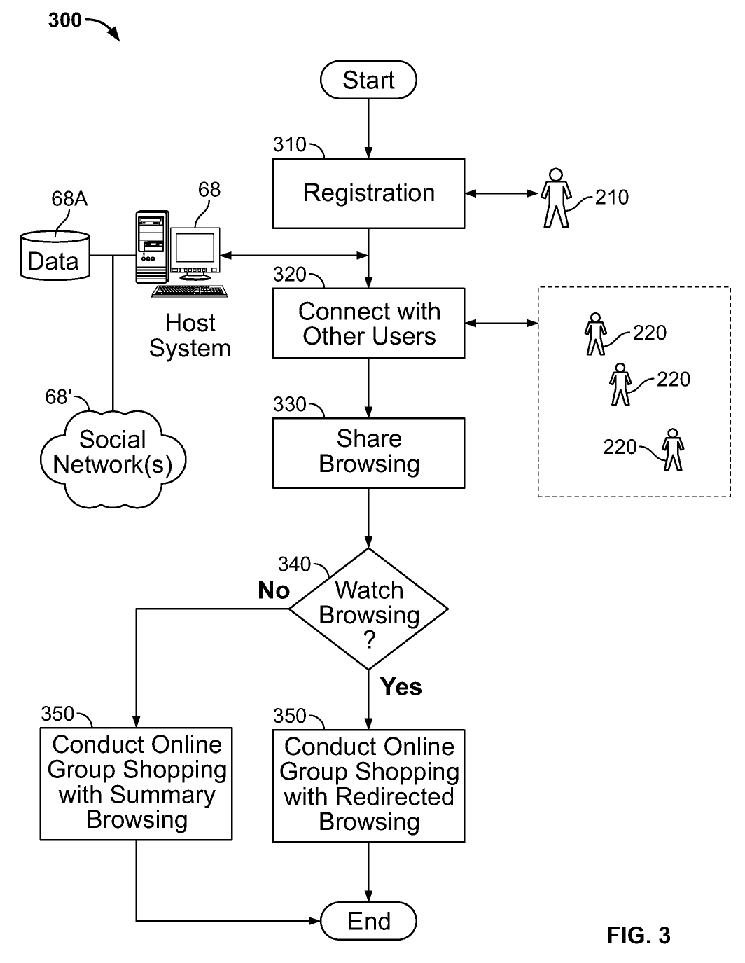

Turning now to FIG. 3, to provide the user 210 with the capability to conduct an online group shopping experience, the system 200 includes a registration and sharing process 300. In this example, the process 300 begins with a registration/login process at a block 310. The registration/login process 310 provides a secure (e.g., password protected) access to the system 200. Typically, the registration process will include the ability to cull the user's already existing social media accounts and/or electronic address book to suggest various friends and/or contacts for inclusion in the shopper's network.

Once the registration process is complete, the process 300 continues with a connection process at block 320. As noted the connection process may include the culling of already existing contacts, and/or may provide the user 210 the ability to manually search for any other users to become friends of the user 210, or browse a listing of participating people whom the user may know to invite those participants as well. The system 200 strives to create a shared shopping experience to connect the user 210 with friends and/or experts, who similarly care where and with whom the user shops such that both users may take advantage of all of the items stored in the data repository 68A.

Once the relationship between users is established, the user 210 then proceeds to share their browsing with selected individuals at block 330. For example, the user 210 can share their browsing activity with a chat partner as desired. Once the user 210 initiates a shared browsing session, the chat partner (e.g., user 220) can choose to watch the shared browsing session and/or ignore the shared browsing session at block 340. If the user decides to ignore the shared browsing session, the online group shopping event will not take place, but both users are free to chat and/or continue to shop on the merchant website as desired. If, however, the user 220 decides to accept and watch the users 210 browsing, the system 300 performs an online group shopping session at block 350, as will be described below.

The process 300 may utilize the server 68, the data repository 68A and the social media site 68′ to provide each of the users with enhanced services, including, for instance, education (product, trends, etc), training (e.g., use of products, improvements, etc.), provide and/or receive feedback on purchases and/or preferences. By adding the social media aspect 68′ the described system 200 may become viral, fun, and/or competitive (e.g., leader boards, badges, etc.). Moreover, the system 200 may track the best and/or most active users and suggest connections between various users based upon metric and analyzed performances.

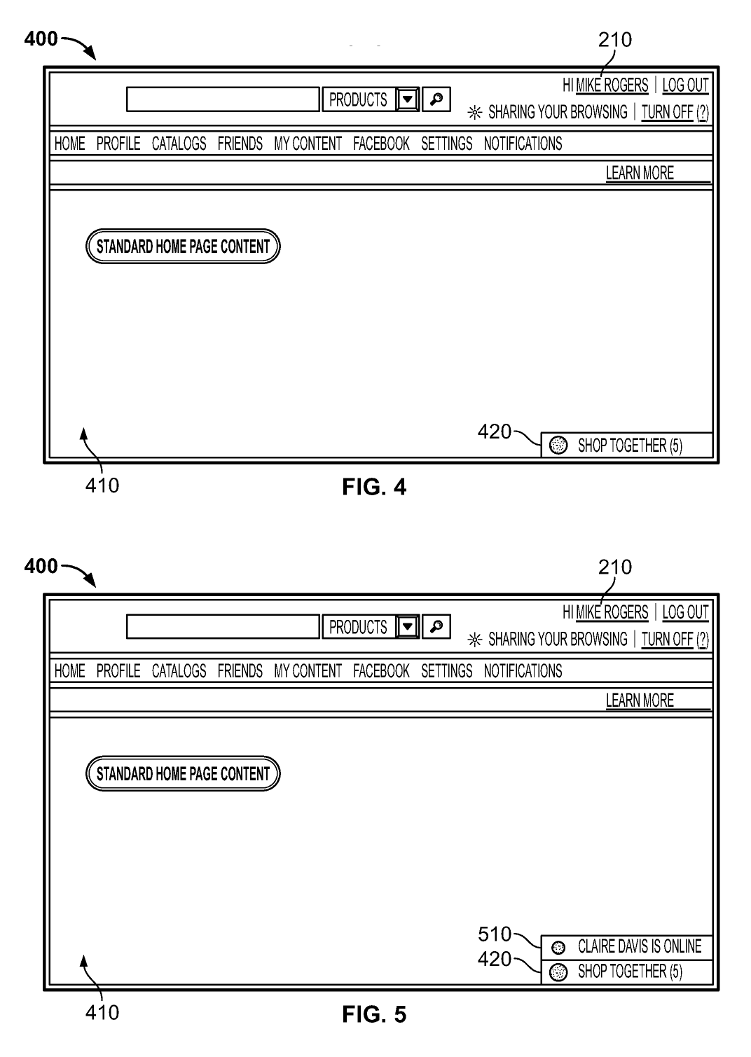

Referring to FIGS. 4-16, example user interfaces for creating the online group shopping experience 300 are illustrated. In this example, the user 210 signs-in to the system 200 as shown in the interface 400. Once logged-in to the system, 200, the interface 400 presents the user 210 with a standard home page content, such as, for instance, a news feed, a shopping page, user activity updates, etc. at an interface portion 410. The interface 400 will also provide the user 210 with the ability to initiate a group shopping experience at the interface portion 420 (e.g., a chat box).

In this example, the chat box interface portion 420 will remain in its position (e.g., in the bottom right corner of the interface 400) even when the user scrolls the underlying page. The interface portion 420 displays the user's 210 current “presence status” via, in this example, a color indicator such as green (online) and grey (offline), although any visual and/or other indicator may suitably be used. The chat box interface 420 will also optionally display the number of friends who are currently on the website and also have their presence status set to “online”. In the present example, the user's status is automatically set to “online”, wherein the presence status will change to “offline” automatically a predetermined time after the user closes the web browser, leaves (e.g., navigates away from) the underlying website, and/or otherwise indicates that they are offline (e.g. logouts, changes their status to offline). It will be appreciated by one of ordinary skill in the art that the status portion 420 and or the interface 400 may provide a real-time indicator and/or notification of an additional user coming online as shown in FIG. 5 a the interface 510.

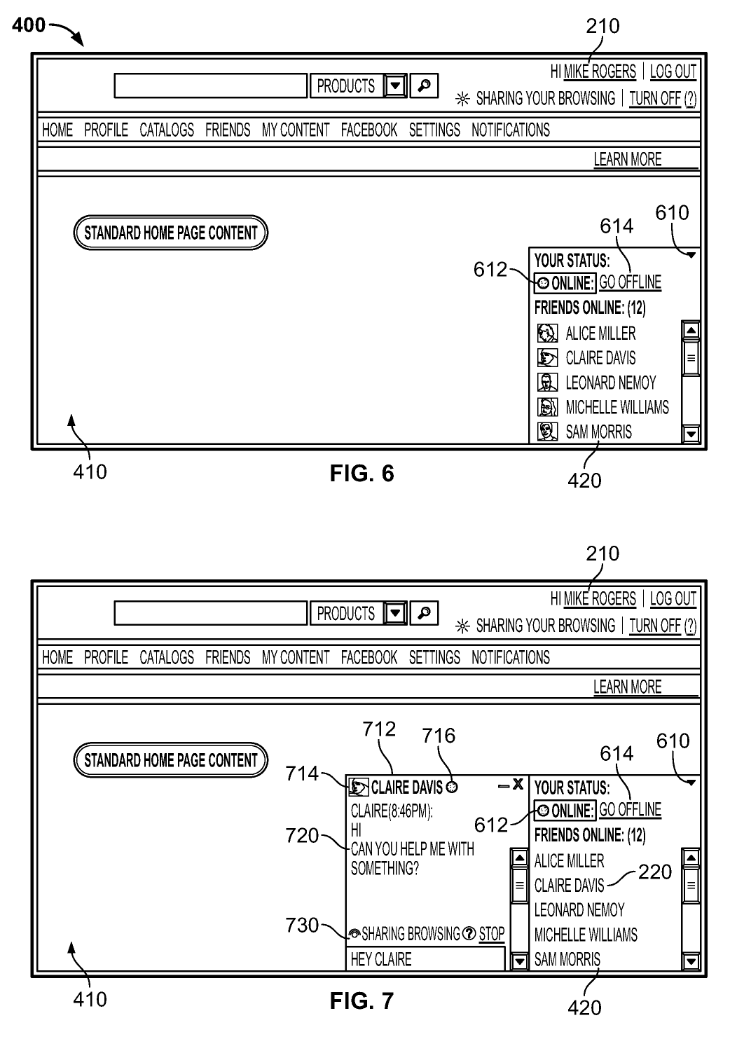

As illustrated in FIG. 6, if the user 210 selects the interface 420, the window expands to its maximum size to provide a visual indication of at least a portion of a listing of the user's 210 friends that are currently online As shown in FIG. 6. For example, the interface 420 may display the user's current status, number of online friends and/or a listing of online friends. By choosing the “minimize” arrow 610, the interface 420 returns to its minimized state. In this example, the interface 420 is persistent across all pages of the underlying webpage, but can be selectively persistent and/or temporary as desired. As illustrated, the user 210 can change their presence status by choosing the online/offline status indicators 612, 614. In this example, when the user 210 has chosen to be “offline” the listing of friends will no longer be displayed to the user 210.

Turning to FIG. 7, if the user 210 selects the name of one of their friends (e.g., user 220), the interface 400 displays a chat box 710 opening a chat room between the user 210 and the selected user 220 as is known in the art. In this example, the chat box 710 displays the name 712, image 714, and presence status indicator 716 of the selected user 220, as well as chat content 720. In addition, the chat box 710 provides a selectable indicator 730 of the sharing status of the users browsing. For instance, in this example illustrated in FIG. 7, the user 210 is currently indicated as sharing their browsing. Finally, in this example, the chat box 710 provides a text entry box 740 allowing the user 210 to provide an instant text message to the user 220. In at least one example, clicking of the name 712 or the image 714 of the user 220 displays the user's 220 profile.

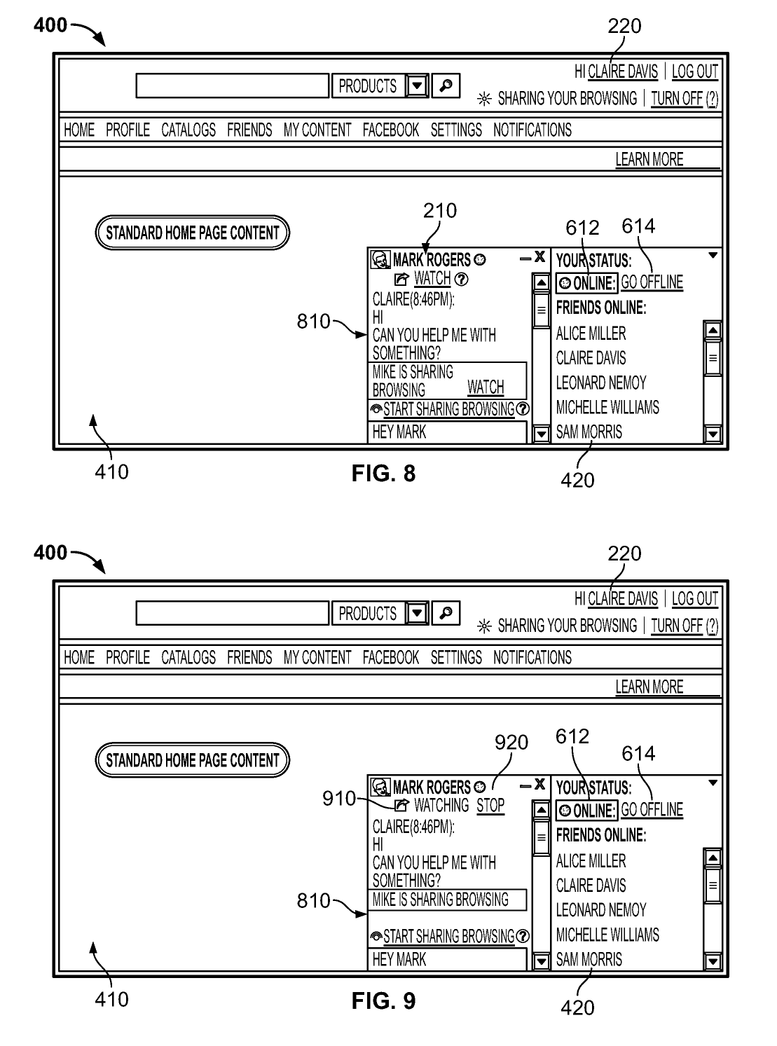

As previously noted, the user 210 can share their browsing (i.e., what pages/items in the underlying web page the user 210 is looking at) with the selected user 220, such as for example the chat partner. For instance, as illustrated in FIG. 8, which is an example of the interface 400 from the perspective of the user 220, the user 220 will be provided with a notification and an option to “watch” the user 210 who is attempting to share browsing at an interface 810. By selecting the “watch” option, the user will automatically be redirected to the same page as being viewed by the user 210 whenever the user 210 navigates to a webpage. If the user 220 does not chose the “watch” option, the user 220 will see a textual description of where the user 210 is navigating in the chat box 710, but will not automatically be redirected to the same page as being viewed by the user 210.

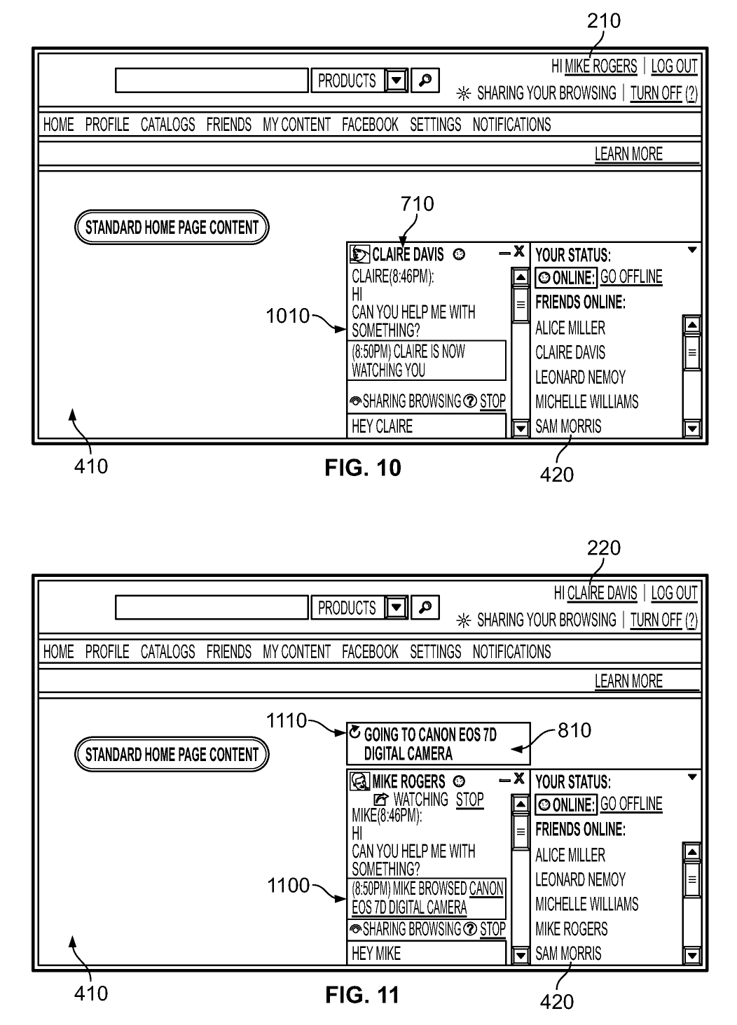

More particularly, as illustrated in FIGS. 9 and 10, if the user 220 choses to watch the browsing of the user 210, an indicator 910 will be displayed to the user 220 to visually indicate that they are actively watching the user 210. Meanwhile, as shown in FIG. 10, the user 210 will receive an indication 1010 that they are being “watched” by the user 220. The user 220 who is watching the user 210 can “stop” watching at any time by clicking the “stop” indicator 920. In the case where the user 220 stops watching the user 210, the indicator at the top of the chat room 810 changes back to “Watch”. If either user 210, 220 closes their respective chat box 810, 710, any “watching” is stopped.

In the example system 200, the following types of navigational pages are currently being shared between the users 210, 220: product pages, catalog pages, search results pages, and profile pages. While the noted pages are currently selected by the system 200 for sharing between users, it will be appreciated by one of ordinary skill in the art that the types and/or number of pages that are shared may be varied as desired. Additionally, while the shared pages are currently described as being predetermined by the system 200, in another example, the chosen pages may be selected by one or more of the users 210, 220, to allow for a customized navigational experience.

While browsing is being shared, the watching user 220 will automatically be taken to the page that the user 210 has navigated to as illustrated in FIG. 11. Specifically, in this example, the user 210 has navigated to a product page associated with a digital camera and a message 1100 is inserted into the chat content 710, 810 area for both users 210, 220 in the chat room as shown at a message box 1110. Additionally, a message 1110 describing the impending navigation is displayed to the user 220 as shown.

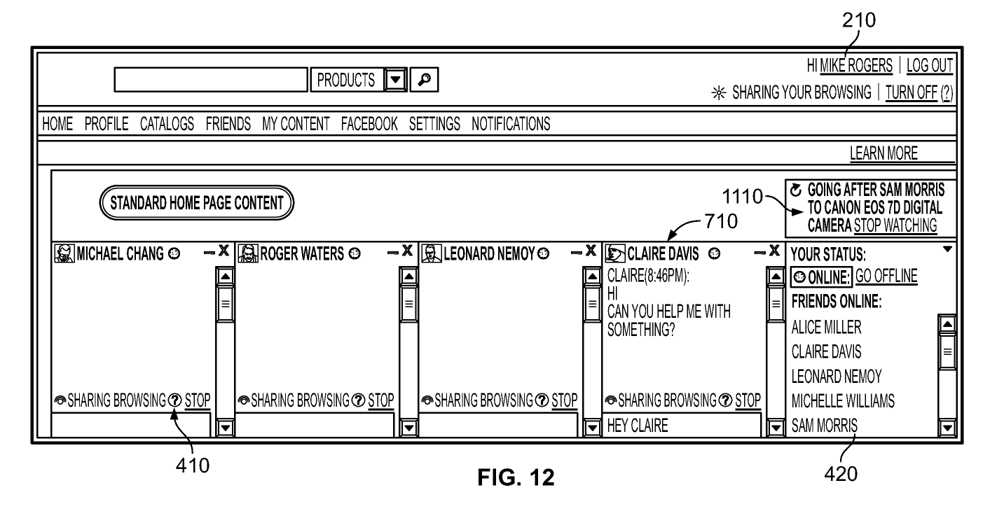

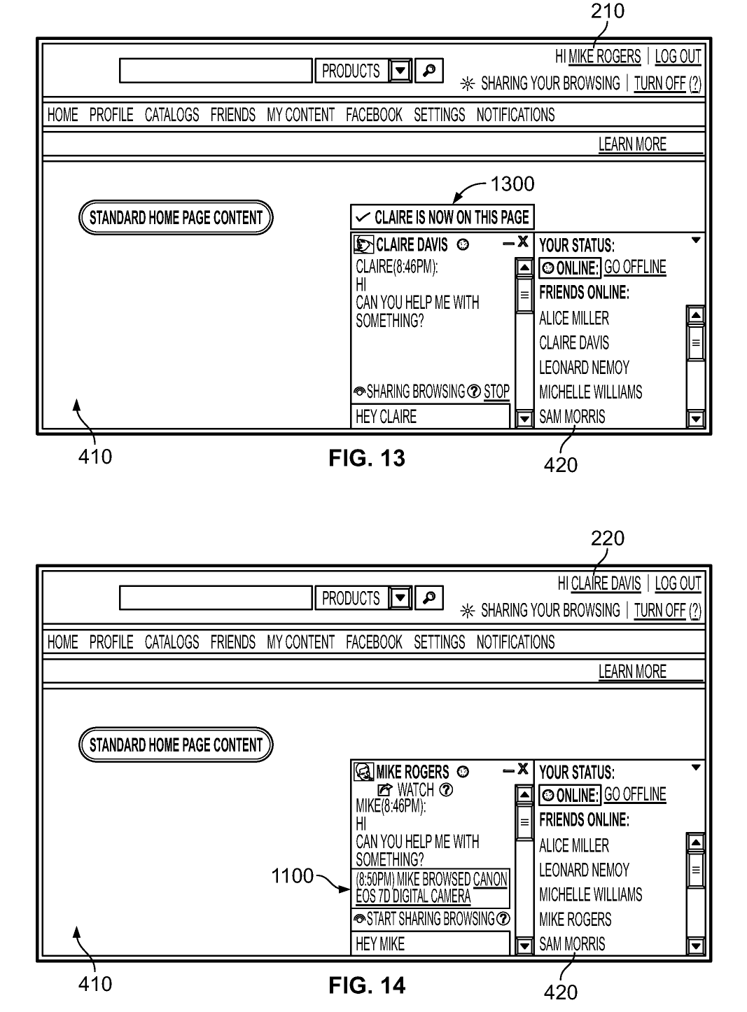

If automatic navigation is triggered by a watched user 210 who belongs to a chat room that is not currently displayed (e.g. because there are too many other more recent chat rooms displayed, the navigation message 1110 is displayed above the chat box 420 as illustrated in FIG. 12. Similarly, when the automatic redirection of the “watching” user 220 is complete, a message 1300 is displayed above the chat room box 420 to the user 210 who is being “watched” as illustrated in FIG. 13.

As previously described, if the user 210 is sharing browsing but the user 220 is not “watching” the user 210, the user 220 will not be automatically redirected to the pages browsed by the user 210 but the pages will still appear in the content area of the chat room at 1100 as shown in FIG. 14.

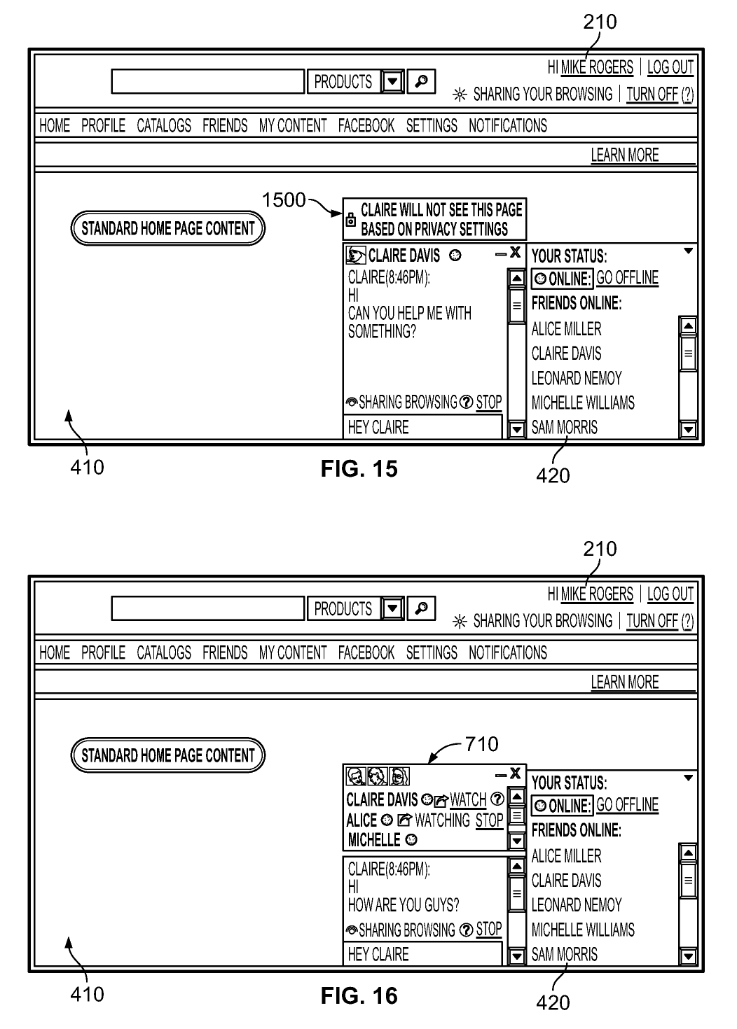

Turning to FIG. 15, if a watched user 210 browses an object that the user 220 cannot see based on the privacy settings of the object itself and/or the privacy settings of the user 210, a message, such as, for example as displayed at interface 1500, will not appear and the user 220 will not be redirected to that page. In any case, the user 220 sees any page based on privacy settings, and not necessarily the way the user 210 sees that page. In other words, when a watched user 210 is browsing a page that cannot be seen by the watching user 220 based on privacy settings, a message will be displayed next to the chat room box to the watched user.

As will be understood by one of ordinary skill in the art a user 210 can start a chat room 710 with multiple users 220 as illustrated in FIG. 16. In this example, the chat room 710 displays an indication of the multiple user 220 in the chat. For example, as illustrated, the room 710 may display up to six images of the users 220 along with the names of each of the users 220. Watching can start on each of the participants in the chat that have their “sharing browsing” set to “on”. In this example, when a user 210 starts watching one user 220 while watching another user 220, the previous user 220 watching is stopped in favor of the most recent watching request. Moreover, in this example, the “sharing browsing” setting applies to all participants in the chat room 710 such that if user A is in a chat room with users B and C and decides to share her browsing, both users B and C will receive browsing messages and be able to watch user A.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A computer-readable media having stored thereon computer executable instructions, wherein the instructions perform steps for providing an online group shopping experience via a computing device, comprising:
hosting a database of information regarding a first user;
hosting a database of information regarding a second user;
associating the first user with the second user;
providing a first user interface on a first display to display information of at least one of a product or a service to the first user;
providing a second user interface on a second display to display information of at least one of a product or a service to the second user;
selectively allowing the first user to share a summary of the displayed information on the first display with the second user;
displaying the shared summary of the displayed information on the second display; and
allowing the second user to display the information of the at least one of a product or a service on the second display in response to receiving from the first user a shared summary of the displayed information on the second display.

2. A computer-readable media as defined in claim 1, wherein at least one of the first and second user interfaces is a webpage.

3. A computer-readable media as defined in claim 1, wherein the shared summary is displayed in a chat box.

4. A computer-readable media as defined in claim 1, wherein at least one of the first and second interfaces is provided on at least one of a personal computer, a mainframe computer, a personal-digital assistant (“PDA”), a cellular telephone, a mobile device, a tablet, or an ereader.

5. A computer-readable media as defined in claim 1, further comprising selectively disallowing the sharing of information between the first and second user based upon a privacy setting.

6. A computer-readable media as defined in claim 1, wherein the product or service is provided by a retail organization.

7. A computer-readable media as defined in claim 1, wherein purchase of the at least one of a product or a service by at least one of the first or second user provides for a reward to at least one of the first and second user.

8. A computer-readable media as defined in claim 7, wherein the reward is a loyalty reward.

9. A computer-readable media as defined in claim 7, wherein purchase of the at least one of a product or a service is performed through at least one of an on-line or off-line purchase event.

10. A computer-readable media as defined in claim 7, wherein the reward is a commission based upon the sale price of the product or service.

11. A computer-readable media as defined in claim 1, wherein associating the first user with the second user is provided by a social media service.

12. A computer-readable media as defined in claim 1, wherein associating the first user with the second user includes a determination of the connection between the first user and the second user.

13. A computer-readable media as defined in claim 12, wherein the determination of the connection between the first user and the second user comprises a social connection.

14. A computer-readable media as defined in claim 13, wherein the social connection is determined through the query of a social media application.

15. A computer-readable media as defined in claim 1, further comprising hosting a database of information related to a plurality of products or services, and wherein the information of at least one product or service is selected from the plurality of products and services.

16. A computer-readable media as defined in claim 15, wherein the database of information related to a plurality of products or services is hosted by a retail establishment.

17. A computer-readable media as defined in claim 1, wherein the first user interface and the second user interface allow the first user and the second user the ability to discuss the recommended product or service.

18. A computer-readable media as defined in claim 17, wherein the ability to discuss the recommended product or service is provided through at least one of voice, text, email, or video.

19. A system for providing an online group shopping experience via a computing device, comprising:
a database of information regarding a first user and a second user, wherein the first user is associated with the second user;
a first user interface on a first display to display information of at least one of a product or a service to the first user;
a second user interface on a second display to display information of at least one of a product or a service to the second user; and
a network for selectively allowing the first user to share a summary of the displayed information on the first display with the second user,
wherein the network allows for the displaying of the shared summary of the displayed information on the second display, and
wherein the network allows for the second user to display the information of the at least one of a product or a service on the second display in response to receiving from the first user a shared summary of the displayed information on the second display.

20. A system as defined in claim 19, wherein at least one of the first and second user interfaces is a webpage.

21. A system as defined in claim 19, wherein the shared summary is displayed in a chat box.

22. A system as defined in claim 19, wherein at least one of the first and second interfaces is provided on a personal computer, a mainframe computer, a personal-digital assistant (“PDA”), a cellular telephone, a mobile device, a tablet, or an ereader.

23. A system as defined in claim 19, wherein purchase of the at least one of a product or a service by at least one of the first or second user provides for a reward to at least one of the first and second user.

24. A system as defined in claim 19, wherein associating the first user with the second user is provided by a social media service.

25. A system as defined in claim 19, wherein the first user interface and the second user interface allow the first user and the second user the ability to discuss the recommended product or service.

26. A system as defined in claim 25, wherein the ability to discuss the recommended product or service is provided through at least one of voice, text, email, or video.
